(19) United States
(12) Patent Application Publication
(10) Pub. No.: US 2015/0212489 A1
(43) Pub. Date: Jul. 30, 2015

(54) APPARATUS AND METHOD FOR GENERATING HOLOGRAM

(71) Applicant: Electronics and Telecommunications Research Institute, Daejeon (KR)

(72) Inventors: Ho Yong SEO, Daejeon (KR); Beom Ryeol LEE, Daejeon (KR)

(21) Appl. No.: 14/602,184

(22) Filed: Jan. 21, 2015

(30) Foreign Application Priority Data
Jan. 29, 2014 (KR) 10-2014-0011314

(51) Int. Cl. G03H 1/08

(52) U.S. Cl. CPC G03H 1/0866; G03H 1/0808; G03H 2001/0883

(57) ABSTRACT

Provided are an apparatus and a method for generating a hologram, wherein the hologram generating apparatus includes an interface to receive location based image data of an object from cameras and a processor to generate hologram data of the object by determining a middle point located between a pair of adjacent cameras, generating image interpolation data corresponding to the middle point, synthesizing the location based image data and the image interpolation data.

### CROSS-REFERENCE TO RELATED APPLICATION

This application claims the priority benefit of Korean Patent Application No. 10-2014-0011314, filed on Jan. 29, 2014, in the Korean Intellectual Property Office, the disclosure of which is incorporated herein by reference.

### BACKGROUND

1. Field of the Invention

The present invention relates to an apparatus and a method for generating a hologram providing elaborate panorama-based hologram data about an object.

2. Description of the Related Art

A hologram is considered a three-dimensional (3D) photograph differing from a general two-dimensional (2D) photograph. Aside from being used to observe a front view, the general 2D photograph may not be used to observe a side view or verify whether a resolution of a screen is changed depending on a change in a focal point because no 3D information is included in the general 2D photograph.

However, a hologram functioning as a 3D photograph may be used to observe side view information and a change in a focal point in addition to a front view while changing an observation viewpoint.

Thus, there is a desire for technology for generating hologram data based on a successive panorama capturing an object and maximizing a holographic characteristic as a 3D image.

### SUMMARY

According to example embodiments of the present invention, elaborate panorama-based hologram data of an object may be provided by generating image interpolation data corresponding to a middle point between locations from location based image data of the object, and generating the hologram data of the object by synthesizing the location based image data and the image interpolation data corresponding to the middle point.

According to example embodiments of the present invention, an overload that may occur in a camera when generating hologram data may be prevented in advance by generating the hologram data of an object using location based image data of the object received from the camera and providing the generated hologram data to the camera.

According to an aspect of the present invention, there is provided a hologram generating apparatus including an interface to receive location based image data of an object from cameras and a processor to generate hologram data of the object by determining a middle point located between a pair of adjacent cameras, generating image interpolation data corresponding to the middle point, and synthesizing the location based image data and the image interpolation data.

According to another aspect of the present invention, there is provided a hologram generating method including receiving location based image data of an object from cameras, determining a middle point located between a pair of adjacent cameras and generating image interpolation data corresponding to the middle point, and generating hologram data of the object by synthesizing the location based image data and the image interpolation data.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of a configuration of a network including a hologram generating apparatus according to an embodiment of the present invention;

FIG. 2 is a diagram illustrating an example of a configuration of a camera communicating with a hologram generating apparatus according to an embodiment of the present invention;

FIG. 3 is a diagram illustrating an example of a configuration of a hologram generating apparatus according to an embodiment of the present invention; and

FIG. 4 is a flowchart illustrating a hologram generating method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

A hologram generating apparatus to be described hereinafter may be based on digital holography technology.

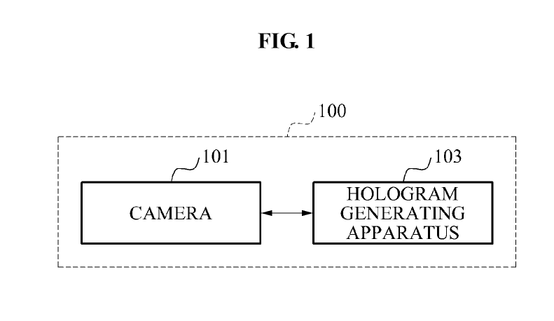

FIG. 1 is a diagram illustrating an example of a configuration of a network 100 including a hologram generating apparatus 103 according to an embodiment of the present invention.

Referring to FIG. 1, the network 100 includes a camera 101 and the hologram generating apparatus 103.

The camera 101 obtains image data by capturing an object and transmits the image data corresponding to a location of the camera 101 to the hologram generating apparatus 103.

Here, the camera 101 may include a plurality of cameras located separate from one another. Each camera transmits location based image data obtained by capturing the object at a location separate from another camera. The obtained image data may be two-dimensional (2D) image data or three-dimensional (3D) image data as described herein.

Alternatively, the camera 101 may be a single camera obtaining location based image data by tracking a changed location when a location or a posture of the camera 101 is changed based on the object, and transmitting the obtained location based image data to the hologram generating apparatus 103.

When a restoration request is input from a user, the camera 101 transmits the restoration request to the hologram generating apparatus 103, and provides a 3D image by receiving hologram data of the object from the hologram generating apparatus 103 and visualizing the hologram data in response to the restoration request.

The hologram generating apparatus 103 receives the location based image data of the object from the camera 101. The hologram generating apparatus 103 determines a middle point located between a pair of adjacent cameras, generates image interpolation data corresponding to the middle point, synthesizes the location based image data and the image interpolation data, generates the hologram data of the object, and stores the hologram data in a database.

For example, the hologram generating apparatus 103 may perform a graphics processing unit (GPU) based parallel calculation or a calculation for image data synthesis based on a grid computing environment.

The hologram generating apparatus 103 may prevent an overload that may occur in the camera 101 when generating the hologram data by performing all calculations used to generate the hologram data of the object in place of the camera 101. In addition, the hologram generating apparatus 103 may desirably operate in a low-capacity storage environment by compressing the hologram data of the object and storing and maintaining the hologram data in the database. However, the hologram generating apparatus 103 may not be limited thereto and manage the data using an external storage, for example, a cloud system and an Internet based storage.

The hologram generating apparatus 103 obtains the hologram data of the object from the database in response to the restoration request from the camera 101, and provides the obtained hologram data to the camera 101.

The hologram generating apparatus 103 provides the hologram data of the object to the camera 101 to allow the 3D image of the object that may be changed based on a view to be observed to be displayed.

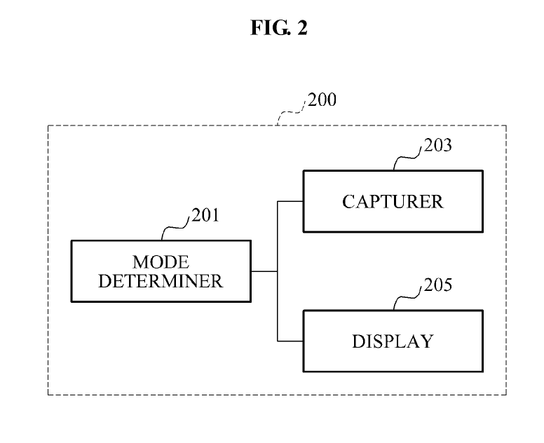

FIG. 2 is a diagram illustrating an example of a configuration of a camera 200 communicating with a hologram generating apparatus according to an embodiment of the present invention.

Referring to FIG. 2, the camera 200 includes a mode determiner 201, a capturer 203, and a display 205.

The mode determiner 201 determines a status mode to be a hologram generation mode or a hologram restoration mode based on an input from a user.

When the status mode is the hologram generation mode, the capturer 203 obtains image data by capturing an object, and transmits the image data corresponding to a location, for example, calibration and an angle, of the camera 200 to the hologram generating apparatus. The capturer 203 obtains location based image data by tracking a changed location as a location of the camera 200 is changed based on the object, and transmits the obtained location based image data to the hologram generating apparatus.

When the status mode is the hologram restoration mode and a restoration request is input from the user, the display 205 transmits the restoration request to the hologram generating apparatus, and provides a 3D image by receiving the hologram data of the object from the hologram generating apparatus and visualizing the hologram data in response to the restoration request.

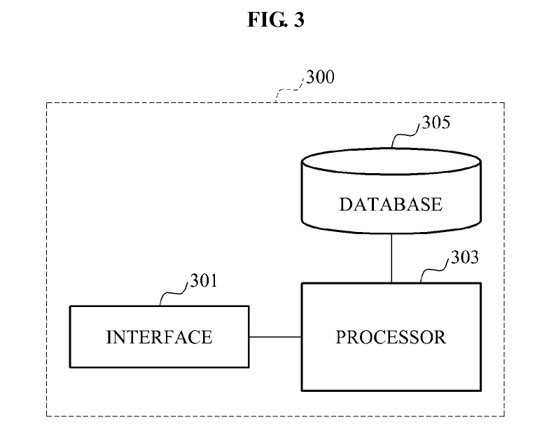

FIG. 3 is a diagram illustrating an example of a configuration of a hologram generating apparatus 300 according to an embodiment of the present invention.

Referring to FIG. 3, the hologram generating apparatus 300 includes an interface 301, a processor 303, and a database 305.

The interface 301 receives location based image data of an object from a plurality of cameras. The cameras may be separate from one another, and located at different angles from the object.

The interface 301 receives the location based image data obtained by capturing the object as a camera in a status mode of a hologram generation mode among the cameras changes a location of the camera.

The processor 303 determines a middle point located between a pair of adjacent cameras and generates image interpolation data corresponding to the middle point. When each camera transmits location based image data obtained by capturing the object from a location separate from another camera, the processor 303 generates the image interpolation data corresponding to the middle point using two sets of location based image data received in association with the pair of the adjacent cameras. The location separate from another camera may be calculated through calibration of each camera.

The processor 303 generates hologram data of the object by synthesizing the location based image data and the image interpolation data. The processor 303 restores the image interpolation data corresponding to the middle point with respect to the location based image data and uses the image interpolation data to generate the hologram data of the object. Thus, the processor 303 generates a panorama-based 3D image by interpolating image data of an intermediate view.

The database 305 stores the hologram data of the object and provides the stored hologram data in response to a restoration request from a camera in a status mode of a hologram restoration mode among the cameras to allow a camera to display the 3D image.

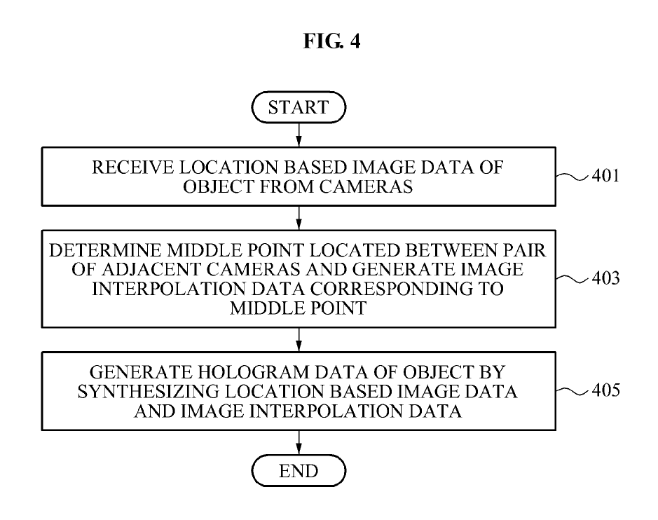

FIG. 4 is a flowchart illustrating a hologram generating method according to an embodiment of the present invention.

Referring to FIG. 4, in operation 401, a hologram generating apparatus receives location based image data of an object from a plurality of cameras. The hologram generating apparatus receives the location based image data obtained by capturing the object as a camera in a status mode of a hologram generation mode among the cameras changes a position of the camera.

In operation 403, hologram generating apparatus determines a middle point located between a pair of adjacent cameras and generates image interpolation data corresponding to the middle point. When each camera transmits location based image data obtained by capturing the object from a location separate from another camera, the hologram generating apparatus generates the image interpolation data corresponding to the middle point using two sets of location based image data received in association with the pair of the adjacent cameras.

The location separate from another camera may be calculated through calibration of each camera.

In operation 405, the hologram generating apparatus generates hologram data of the object by synthesizing the location based image data and the image interpolation data, and stores the generated hologram data in a database.

The hologram generating apparatus provides the stored hologram data in response to a restoration request from a camera in a status mode of a hologram restoration mode among the cameras.

According to example embodiments of the present invention, elaborate panorama-based hologram data of an object may be provided by generating image interpolation data corresponding to a middle point between locations from location based image data of the object, and generating the hologram data of the object by synthesizing the location based image data and the image interpolation data corresponding to the middle point.

According to example embodiments of the present invention, an overload that may occur in a camera when generating hologram data may be prevented in advance by generating the hologram data of an object using location based image data of the object received from the camera and providing the generated hologram data to the camera.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments that accomplish the examples disclosed herein can be easily construed by programmers skilled in the art to which the examples pertain based on and using the flow diagrams and block diagrams of the figures and their corresponding descriptions as provided herein.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A hologram generating apparatus, comprising:
an interface to receive location based image data of an object from a plurality of cameras; and
a processor to generate hologram data of the object by determining a middle point located between a pair of adjacent cameras, generating image interpolation data corresponding to the middle point, and synthesizing the location based image data and the image interpolation data.

2. The apparatus of claim 1, wherein each camera transmits location based image data obtained by capturing the object from a location separate from another camera, and
the processor generates the image interpolation data corresponding to the middle point using two sets of location based image data received in association with the pair of the adjacent cameras.

3. The apparatus of claim 2, wherein the location separate from another camera is calculated through calibration of each camera.

4. The apparatus of claim 1, wherein the interface receives location based image data obtained by capturing the object as a camera in a status mode of a hologram generation mode among the cameras changes a location of the camera.

5. The apparatus of claim 1, further comprising:
a database to store the hologram data and provide the stored hologram data in response to a restoration request by a camera in a status mode of a hologram restoration mode among the cameras.

6. A hologram generating apparatus, comprising:
an interface to receive location based image data of an object from a plurality of cameras in a status mode of a hologram generation mode;
a processor to generate hologram data of the object by determining a middle point located between a pair of adjacent cameras, generating image interpolation data corresponding to the middle point, and synthesizing the location based image data and the image interpolation data; and
a database to store the hologram data and provide the stored hologram data in response to a restoration request by a camera in a status mode of a hologram restoration mode.

7. The apparatus of claim 6, wherein each camera transmits location based image data obtained by capturing the object from a location separate from another camera, and
the processor generates the image interpolation data corresponding to the middle point using two sets of location based image data received in association of the pair of the adjacent cameras.

8. The apparatus of claim 7, wherein the location separate from another camera is calculated through calibration of each camera.

9. A hologram generating method, comprising:
receiving location based image data of an object from a plurality of cameras;
determining a middle point located between a pair of adjacent cameras and generating image interpolation data corresponding to the middle point; and
generating hologram data of the object by synthesizing the location based image data and the image interpolation data.

10. The method of claim 9, wherein, when each camera transmits location based image data obtained by capturing the object from a location separate from another camera, the generating of the image interpolation data comprises generating the image interpolation data corresponding to the middle point using two sets of location based image data received in association with the pair of the adjacent cameras.

11. The method of claim 10, wherein the location separate from another camera is calculated through calibration of each camera.

12. The method of claim 9, wherein the receiving comprises receiving location based image data obtained by capturing the object as a camera in a status mode of a hologram generation mode among the cameras changes a location of the camera.

13. The method of claim 9, further comprising:
storing the hologram data and providing the stored hologram data in response to a restoration request by a camera in a status mode of a hologram restoration mode.
